(19) United States
(12) Patent Application Publication
(10) Pub. No.: US 2026/0262001 A1
(43) Pub. Date: Sep. 3, 2026

(54) METHOD AND SYSTEM FOR SEARCHING FOR A BEACON USING A DETECTION DEVICE

(71) Applicant: ACTILITY, LANNION (FR)

(72) Inventors: Fabien PHILIPPE, TRESSERVE (FR); Nicolas SORNIN, LA TRONCHE (FR)

(73) Assignee: ACTILITY, LANNION (FR)

(21) Appl. No.: 18/871,338

(22) PCT Filed: Jun. 1, 2023
(86) PCT No.: PCT/FR2023/050770

§ 371 Date: Dec. 3, 2024

(30) Foreign Application Priority Data
Jun. 3, 2022 (FR) FR2205391

(51) Int. Cl. H04W 64/00; H04B 17/318; H04W 8/22

(52) U.S. Cl. CPC H04W 64/00; H04B 17/318; H04W 8/22

(57) ABSTRACT

A method for searching for a beacon, the searching method being carried out by a detection device including a geolocation terminal able to determine current geolocation coordinates of the detection device and to determine at least one location position of the beacon on the basis of the current geolocation coordinates of the detection device and of a determined separation distance between the detection device and the beacon.

### TECHNICAL FIELD

The present invention relates to a method and system for searching for a target beacon that could be attached to an object or to a living being to be searched for.

### PRIOR ART

It is known to make a portable beacon for professionals and practitioners of mountain sports. This beacon may be attached to an object or to a living being to be searched for and may be part of a beacon detection system further comprising a device for detecting the beacon.

For example, this system for searching for the beacon may be particularly useful for searching for victims of an avalanche. Thanks to this system for searching for beacons, it becomes possible to locate a person in a natural environment like in mountain and to rescue him/her when he/she is facing a critical situation.

When the beacon comprises a geolocation coordinate receiver such as a GPS receiver, approaching the detection device is performed simply by heading towards the GPS coordinates of the beacon. In this case, the beacon emits its GPS coordinates periodically and the detection device receives these coordinates and determines the heading and the distance according to the received GPS coordinates and according to its own position.

However, under some conditions, the receiver of the geolocation coordinates of the beacon does not operate at all or does not operate in a sufficiently reliable manner. This might occur if the beacon is buried under snow, if it is in a closed space, or if the beacon is located under a rocky overhang or at the foot of a cliff. Moreover, if the beacon is at a significant distance from the receiver, measurement noises might lead to an erroneous calculation of the location of the beacon.

The present invention aims to solve the aforementioned drawbacks.

The technical problem at the origin of the invention consists in particular in providing a system and a method for searching for a beacon which has an emission range longer than several tens of meters, and which allows locating the beacon more reliably, without being based on the geolocation coordinates of the beacon.

### General Description

To this end, the present invention relates to a method for searching for a beacon, the search method being executed by a detection device comprising a geolocation terminal capable of determining current geolocation coordinates of the detection device and a radio receiver capable of detecting a radio signal emitted by the beacon, the search method comprising the following steps:
receiving the radio signal emitted by the beacon;
determining a separation distance between the detection device and the beacon on the basis of a measurement of a time of propagation of the radio signal between the beacon and the detection device, or a measurement of a quantity representative of the power of the radio signal emitted by the beacon and received by the detection device like an RSSI, or a combination of the measurement of the time of propagation of the radio signal and the quantity representative of the power of the radio signal, said step of determining the separation distance between the detection device and the beacon is periodically done so as to have a new estimate of the separation distance at each period when the detection device moves;
determining at least one localization position of the beacon based on the current geolocation coordinates of the detection device and the determined separation distance; the determination of at least one localization position of the beacon comprising the steps of determining a search space of the beacon; dividing the search space into a grid comprising a plurality of sub-areas; assigning relative coordinates to each sub-area, these relative coordinates being fixed for each sub-area and calculated with respect to reference coordinates of a center of the grid, calculating a current probability indicator for each sub-area, for each estimate of the separation distance between the detection device and the beacon, the current probability indicator being representative of the probability that the beacon is within the sub-area, the current probability indicator being calculated according to previous probability indicators and the determined separation distance between the beacon and the detection device and according to the current geolocation coordinates of the detection device, selecting the sub-areas for which the probability indicator has the highest values, as representative of a most probable location of the beacon.

According to one feature, the detection device is moving relative to a terrestrial reference frame and the beacon is fixed relative to the terrestrial reference frame.

According to one embodiment, the geolocation terminal is a satellite geolocation terminal.

According to one embodiment, in the step of determining at least one localization position of the beacon, the grid is loaded on a memory unit of the detection device.

According to one embodiment, the step of determining at least one localization position of the beacon further comprises initializing the grid in the memory unit so that the center of the grid has fixed reference coordinates defined by an initial position of the detection device determined when starting searching for the beacon.

According to one embodiment, the search method comprises a step of determining the dimensions of each sub-area according to a memory available in the memory unit of the detection device.

According to one feature, the current probability indicator takes account of the determined separation distance between the beacon and the detection device in the form of a distance distribution taking account of a measurement error.

According to one feature, the search method comprises a step of determining the dimensions of each sub-area according to a memory available in the memory unit of the detection device.

According to one feature, the detection device is provided with a visual interface, the search method comprising a step of displaying on the visual interface in which the sub-areas for which the probability indicator has the highest values are highlighted.

According to one embodiment, the search space of the beacon (B) is determined from the initial estimate of the separation distance between the detection device and the beacon, and the grid has a dimension larger than at least twice the separation distance initially determined between the detection device and the beacon.

According to one embodiment, the current geolocation coordinates of the detection device originate from at least one source selected from among: a system for geolocation by one or several satellite(s), a triangulation based on Wi-Fi access points detected by the detection device, a trilateration based on Wi-Fi access points detected by the detection device, a trilateration based on cellular base stations detected by the detection device, a simultaneous localization and mapping algorithm based on an analysis of a stream of images captured by the detection device, and a unit for integration of axial and angular accelerations measured by a set of accelerometers and gyroscopes.

The invention also relates to a system for searching for a beacon comprising:
the beacon emitting within a transmission range of the beacon a radio signal comprising identification information of the beacon,
a detection device comprising a geolocation terminal able to determine current geolocation coordinates of the detection device and a radio receiver capable of detecting the radio signal emitted by the beacon, the detection device implementing the search method described hereinbefore, the detection device further comprising a memory unit in which are loaded: a grid which covers a search space of the beacon and which comprises a plurality of sub-areas, each sub-area having relative coordinates calculated with respect to fixed coordinates of a center of the grid, and probability indicators associated with the sub-areas, so that each sub-area has a probability indicator representative of the probability that said sub-area contains the beacon.

According to one feature, the detection device is configured to measure a separation distance between the detection device and the beacon on the basis of a measurement of a time of propagation of the radio signal between the beacon and the detection device, or a measurement of a quantity representative of the power of the radio signal emitted by the beacon and received by the detection device like an RSSI, for example, or a combination of the measurement of the time of propagation of the radio signal and the quantity representative of the power of the radio signal.

According to one feature, the detection device is moving relative to a terrestrial reference frame and wherein the beacon is fixed relative to the terrestrial reference frame.

According to one feature, the search system comprises a visual interface in which the sub-areas for which the probability indicator has the highest values are highlighted in the display.

According to one embodiment, the geolocation terminal of the detection device comprises at least one element selected from among: a system for geolocation by one or several satellite(s), a Wi-Fi or cellular access point detector, an image stream sensor, and an integration unit comprising a set of accelerometers and gyroscopes.

According to one feature, the detection device is included in an aerodyne or a motor vehicle.

According to one embodiment, the invention relates to a motor-propelled vehicle comprising a detection device as described before.

According to one embodiment, the invention relates to an aerodyne comprising a detection device as described before.

### BRIEF DESCRIPTION OF THE FIGURES

The invention will be better understood from the detailed description which is disclosed hereinbelow with reference to the appended drawings, wherein:

FIG. 1 is a schematic representation of a beacon emitting a radio signal within its emission range and of a detection device capable of detecting the beacon.

FIG. 2 shows a diagram showing a discrepancy between a measured separation distance and an actual separation distance between the detection device and the beacon as well as a histogram showing a distribution of this error.

FIG. 3 shows a grid according to which a search space for the beacon is decomposed.

FIG. 4 shows a display of a visual interface of the detection device implementing the method for searching for the beacon.

FIG. 5 shows a display of a visual interface of the detection device implementing the method for searching for the beacon.

In the following detailed description of the figures defined hereinabove, the same elements or elements fulfilling identical functions could keep the same references so as to simplify understanding of the invention. Other features could arise from the following detailed description.

### DESCRIPTION WITH REFERENCE TO THE FIGURES

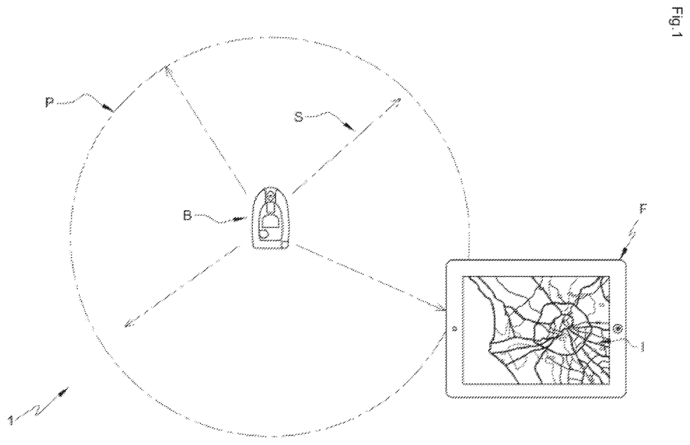

The invention relates to a method for searching for a beacon B. This search method is executed by a detection device F as shown in FIG. 1 and which comprises a geolocation terminal able to determine current geolocation coordinates of the detection device F and a radio receiver capable of detecting a radio signal S emitted by the beacon B. The geolocation terminal may be a GPS receiver and the geolocation coordinates may be GPS coordinates. Nonetheless, the invention is not limited to such a device, and the geolocation terminal may comprise at least one element selected from among: a system for geolocation by one or several satellite(s), a Wi-Fi access point detector, an image stream sensor, and an integration unit comprising a set of accelerometers and gyroscopes. For example, a simultaneous localization and mapping algorithm corresponds to a SLAM-type algorithm, standing for Simultaneous localization and mapping according to the used English terminology. Such an algorithm type comprises constructing and updating a map from a stream of images captured in real-time. Known algorithms comprise, for example, the particle filter, the extended Kalman filter, the covariance intersection or the SLAM graph. A person skilled in the art could refer, for example, to the article presented at the Internet link https://en.wikipedia.org/wiki/Simultaneous localization and mapping to implement such types of algorithms.

In this search method, the detection device F may be moving relative to a terrestrial reference frame and the beacon B may be fixed relative to the terrestrial reference frame.

The beacon B may be attached to an object or to a living being to be searched for and may have an emission range P of the radio signal S longer than 100 m, possibly longer than 500 m, and preferably longer than 1 km.

The beacon B may emit the radio signal S following reception of a request signal from the detection device F.

According to one possibility, the request signal may be emitted by the detection device F several times per second, and for example ten times per second.

According to one possibility, the detection device F is capable of detecting the radio signal S emitted by the beacon B when the detection device F is within the emission range of the beacon B.

First, the radio signal S emitted by the beacon B is received by the detection device.

Afterwards, the detection device F proceeds with a determination of a separation distance between the detection device F and the beacon B on the base a measurement of a time of propagation of the radio signal S between the beacon B and the detection device F, or on a measurement of a quantity representative of the power of the radio signal S emitted by the beacon B and received by the detection device F like an RSSI for example, or a combination of the measurement of the time of propagation of the radio signal S and of the quantity representative of the power of the radio signal S.

The RSSI (standing Received Signal Strength Indication) is a measurement of the reception power level of the radio signal S.

The determination of the separation distance between the detection device F and the beacon B is done periodically so as to have a new estimate of the separation distance at each period when the detection device F moves, for example the estimate of the separation distance may be obtained five to ten times per second.

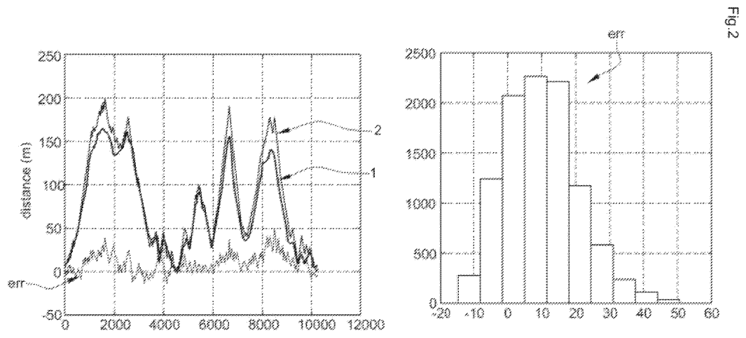

It should be noted that the radio signal S detected by the detection device F is generally noisy because of the presence of disturbing elements such as trees, rocks, or buildings, and that it is consequently not possible to accurately obtain a location of the beacon based only on the calculation of the time of propagation of the radio signal S between the beacon B and the detection device F. For example, FIG. 2 shows the error err resulting from the difference between the separation distance 2 estimated by the detection device F and the actual separation distance 1 between the detection device F and the beacon B as well as a distribution of the corresponding error according to the separation distance in the form of a histogram that represents the error over time.

The detection device F performs an inaccurate initial estimation of the distance that initially separates it from the beacon B before it starts moving on the basis of the radio signal S transmitted by the beacon B. Hence, the beacon B is located approximately on a circle whose radius corresponds to the measured separation distance and whose center corresponds to the current position of the detection device F. The detection device then starts searching for the beacon B by moving in an arbitrary direction.

The detection device F performs a periodic estimation of the distance that separates it from the beacon B when it moves. Advantageously, this estimation of the distance between the detection device F and the beacon B uses a measurement of the time of propagation of the radio signal S between the beacon B and the detection device F, but may also use the power of the radio signal S received by the detection device F originating from the beacon B, or a combination of the measurement of the time of propagation of the radio signal S and of the power of the radio signal S.

Moreover, the detection device being provided with a geolocation coordinate receiver such as a GPS coordinate receiver or any other type of devices allowing determining coordinates, is able to determine at all times its own geolocation data which is called hereinafter current geolocation coordinates.

At each new estimation of the separation distance between the detection device F and the beacon B, for each sub-area, the corresponding probability indicator is recalculated while taking account at least of.
the estimate of the distance between the detection device F and the beacon B;
the current position of the detection device F; and
the previous value of this probability indicator.

The determination of the value of the separation distance may also integrate an estimate of a measurement error of the separation distance carried out a priori and according to the value of the separation distance. FIG. 2 gives such an example of distribution of the measurement error.

In order to determine the at least one localization position of the beacon B, the detection device proceeds, at first, with a determination of a search space of the beacon B. The search space of the beacon B is determined from the initial estimate of the separation distance between the detection device F and the beacon B.

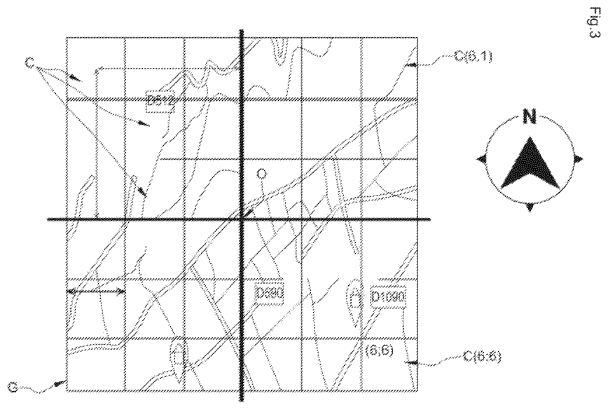

Then, the detection device F proceeds with a division of the search space into a grid G comprising a plurality of sub-areas C as shown in FIG. 3. Each sub-area shows a land parcel of the search space.

The grid G is loaded onto a memory unit of the detection device F. In this memory unit, the grid G is implemented in the form of a table of numbers.

The grid G has a dimension greater than at least twice the separation distance initially determined between the detection device F and the beacon B. This allows ensuring that the position of the beacon B is certainly included in the area covered by the grid G. In practice, a dimension of the grid G equal to three times the separation distance initially determined between the detection device F and the beacon B is selected.

The initial estimate of the distance between the detection device F and the beacon B allows dimensioning the grid G of sub-areas so that the latter contains with a safety margin all of the points of the circle on which the beacon B is located approximately, and therefore all of the possible positions of the beacon B.

The initial dimension of each sub-area is defined according to the initial estimate of the separation distance between the detection device F and the beacon B, and may be calculated according to the following formula when the grid G has a square shape:

$$C . size = \frac{3. {D}_{init}}{m}$$

In this formula, C.size denotes a dimension in meters of a sub-area C of the grid G, Dᵢₙᵢₜ denotes the initial estimate of the distance between the detection device F and the beacon B, and m denotes the number of columns or rows of the grid G. In the case of a square grid G, the latter therefore includes m² sub-areas.

It is possible to determine the dimensions of each sub-area C according to a memory available in the memory unit of the detection device F. Smaller sub-areas enable a more accurate calculation but require more memory available in the memory unit of the detection device F.

Advantageously, it is possible to refine the dimension of the sub-areas C when the available memory enables so in order to estimate the position of the beacon B more accurately.

A step of initializing the grid G in the memory unit follows so that a center O of the grid G has fixed and defined reference coordinates, according to one possibility, by an initial position of the detection device F determined at the time of starting the search for the beacon B. In other words, the coordinates of the center O of the grid G correspond to the geolocation coordinates of the detection device F at the time point when the search for the beacon B begins.

Hence, the center O of the grid G has fixed reference coordinates, for example the coordinates 0, 0, and that being so despite the movement of the detection device F.

Then, relative coordinates are assigned to each sub-area C, these relative coordinates being fixed for each sub-area C and calculated with respect to the reference coordinates of the center O of the grid G.

Afterwards, for each estimate of the separation distance between the detection device F and the beacon B, for each sub-area C, a current probability indicator representative of the probability that the beacon B is included in the sub-area C is calculated.

The current probability indicator is calculated according to the previous probability indicators and the determined separation distance between the beacon B and the detection device F and according to the current geolocation coordinates of the detection device F.

The current probability indicator takes account of the determined separation distance between the beacon B and the detection device F in the form of a distance distribution taking account of a measurement error.

This mechanism of summing up the probabilities allows reducing, throughout the iterations, the possible areas of presence of the beacon B.

The detail of the calculation of the probability indicator is given hereinafter.

An a priori estimation of the distribution pErr of the error of measurement of the separation distance between the detection device F and the beacon B is first provided according to the value of the separation distance.

For simplicity, it is possible to use a distribution pErr that does not vary with the estimated separation distance.

The distribution pErr may be selected by the user of the detection device F according to the radio environment in which the search is performed, for example according to an urban or forest environment.

This distribution pErr may be modeled on the basis of a large number of measurements performed beforehand in several types of environments.

Each time the detection device F performs an estimation of the separation distance with the beacon B, D_est denotes the estimated separation distance, X the first relative coordinate of the detection device F with respect to the center of the grid, and Y the second relative coordinate of the detection device F with respect to the center of the grid. The first coordinate and the second coordinate are given in meters, for example. The relative coordinates of a given sub-area are also denoted C.x and C.y.

For each sub-area C of the grid, and therefore for each box of the table in the memory unit, intermediate quantities are calculated:
a distance D between a center of a sub-area and the detection device according to the formula:

$$D = \sqrt{{( X - C . x )}^{2} + {( Y - C . y )}^{2}}$$

a difference U between the distance estimated by the detection device F and the calculated distance, according to the formula:

$$U = {D}_{est} - D$$

To reach the calculation of the probability indicator C.p according to the formula:

$$C . p\_current = C . p\_previous + {pErr}_{Dest} ( U )$$

Where pErr_{D_est}(U) denotes a probability that the measurement error of the separation distance between the detection device F and the beacon B is equal to U at the distance D_est.

By iterating the calculation described before, the sub-areas C for which the calculated probability indicator is the highest correspond to the most probable locations of the beacon.

Thus, sub-areas C for which the probability indicator has the highest values are selected as representative of a most probable location of the beacon B.

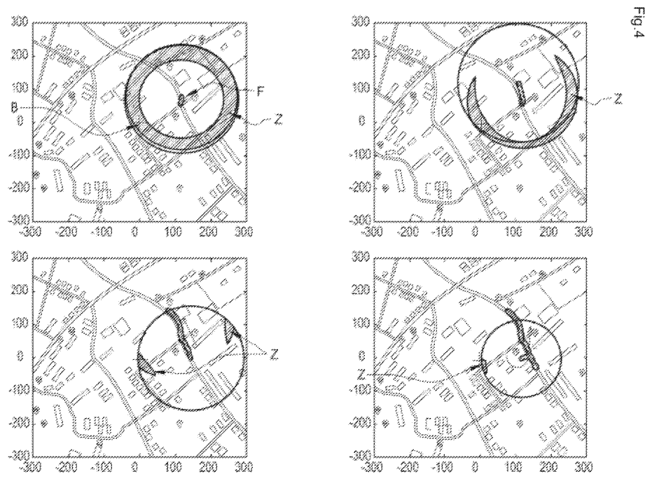

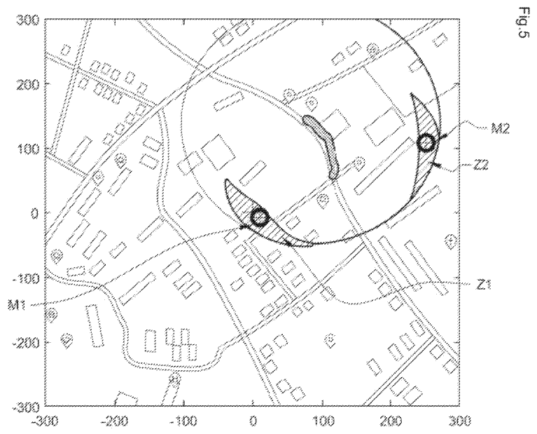

The detection device F may be provided with a visual interface I, and the search method may comprise a step of displaying on the visual interface I in which the sub-areas C for which the probability indicator has the highest values are highlighted like in FIGS. 4 and 5.

By “highlighted”, it should be understood that the sub-areas for which the probability indicator has the highest values are differentiated from the rest of the sub-areas C by a specific color code or a specific marking. For example, the sub-areas C for which the probability indicator has the highest values may be colored.

The visual interface I, which may be a mobile phone screen for example, enables a user of the detection device F to visually locate the position of the beacon B, and consequently modify his/her displacement according to this position.

This allows informing the user, in real-time, on the position of the detection device F with respect to that of the beacon B.

The display of the sub-areas C may be superimposed on a map background as shown in FIGS. 4 and 5.

FIGS. 4 and 5 illustrate an evolution of the probability indicators during the search for the beacon. In FIGS. 4 and 5, the area Z designates the set of sub-areas C for which the probability indicator has the highest values. The movement line of the detection device F is also depicted, and a cross shows an exact position of the desired beacon B, this position being, of course, unknown to the detection device F. A circle with a radius D_est centered on a current position of the detection device F.

In FIG. 4, when the detection device F moves towards the North, the measured separation distance remains the same or increases, and therefore the beacon B cannot be located in the North direction. This is reflected on the area Z which disappears at the North of the detection device. The sub-areas C located at the North of the detection device F then have a probability indicator having a value lower than a limit value of the indicator probability.

Afterwards, the detection device F makes a half-turn and is directed towards the South/South-East. The area Z is then limited to two symmetrical solutions on either side of the direction of movement of the detection device F for locating the beacon B.

As soon as the detection device moves perpendicularly to its initial direction of movement, in the case of FIG. 4 towards the West, one of the two remaining solutions disappears. Since the detection device F approaches the beacon B by going towards the West, the beacon B cannot be located in the solution area that was found at the East.

Finally, one could notice in FIG. 4 that the remaining area Z actually includes the position of the beacon B, initially marked by a cross.

According to an embodiment shown in FIG. 5, the at least one localization position of the beacon B may be defined using a center of gravity M1, M2 respectively of the area Z1, Z2. Indeed, one could see in FIG. 5 that the circle M1 which materializes the center of gravity of the area Z1 corresponds almost to the position of the beacon B. In this case, it is possible to display only the circles M1 and M2 without the areas Z1 and Z2 in order to assist the user of the detection device F in his/her search.

Advantageously, the described search method is simple to implement and could in particular be implemented on a mobile phone. This search method may also be implemented in real-time.

Advantageously, the search method is robust since it is resistant to a measurement noise of the separation distance between the beacon B and the detection device F, and since it supports a given percentage of erroneous measurements.

Advantageously, the search method initially does not make any assumption regarding the position of the beacon B. A priori, the search method considers that any location area of the beacon B is possible and progressively eliminates potential location areas.

The invention further relates to a system 1 for searching for a beacon B for the search method described before and which comprises:
the beacon B emitting within the transmission range of the beacon B a radio signal S comprising identification information of the beacon B,
the detection device F comprising a geolocation terminal able to determine current geolocation coordinates of the detection device F and a radio receiver capable of detecting the radio signal S emitted by the beacon B, the detection device F implementing the search method described before.

According to one possibility, the beacon B is able to send a radio signal S following a request from the detection device F.

According to one possibility, the beacon B comprises a geolocation terminal able to determine geolocation coordinates of the beacon B so that the geolocation coordinates of the beacon B could give an indication for a promising departure point to search for the beacon B.

The detection device F may be configured to measure a separation distance between the detection device F and the beacon B on the basis of a measurement of a time of propagation of the radio signal between the beacon and the detection device, or of a measurement of a quantity representative of the power of the radio signal emitted by the beacon and received by the detection device like an RSSI for example, or a combination of the measurement of the time of propagation of the radio signal and of the quantity representative of the power of the radio signal.

The detection device F may be moving relative to a terrestrial reference frame and in which the beacon B may be fixed relative to the terrestrial reference frame.

The detection device F comprises the memory unit in which are loaded:
the grid G which covers a search space of the beacon B and which comprises a plurality of sub-areas C, each sub-area C having relative coordinates calculated with respect to fixed coordinates of the center O of the grid G, and
probability indicators associated with the sub-areas C, so that each sub-area C has a probability indicator representative of the probability that said sub-area C contains the beacon B.

The search system 1 may further comprise the visual interface I in which the sub-areas C for which the probability indicator has the highest values are highlighted in the display.

The detection device F may be included in an aerodyne or a motor-propelled vehicle.

The detection device F may also be included in a connected computer accessory such as a tablet or a smartphone, or be connected to the display of such a computer accessory.

1. A method for searching for a beacon, the search method being executed by a detection device comprising a geolocation terminal capable of determining current geolocation coordinates of the detection device and a radio receiver capable of detecting a radio signal emitted by the beacon, the search method comprising the following steps:
receiving the radio signal emitted by the beacon;
determining a separation distance between the detection device and the beacon on the basis of a measurement of a time of propagation of the radio signal between the beacon and the detection device, or a measurement of a quantity representative of the power of the radio signal emitted by the beacon and received by the detection device like an RSSI, or a combination of the measurement of the time of propagation of the radio signal and the quantity representative of the power of the radio signal, the said step of determining the separation distance between the detection device and the beacon is periodically done so as to have a new estimate of the separation distance at each period when the detection device moves;
determining at least one localization position of the beacon based on the current geolocation coordinates of the detection device and the determined separation distance; the determination of at least one localization position of the beacon comprising the steps of:
determining a search space of the beacon;
dividing the search space into a grid comprising a plurality of sub-areas;
assigning relative coordinates to each sub-area, these relative coordinates being fixed for each sub-area and calculated with respect to reference coordinates of a center of the grid,
calculating a current probability indicator for each sub-area, for each estimate of the separation distance between the detection device and the beacon, the current probability indicator being representative of the probability that the beacon is within the sub-area,
the current probability indicator being calculated according to previous probability indicators and the determined separation distance between the beacon and the detection device and according to the current geolocation coordinates of the detection device,
selecting the sub-areas for which the probability indicator has the highest values, as representative of a most probable location of the beacon.

2. The search method according to claim 1, wherein in the step of determining at least one localization position of the beacon, the grid is loaded on a memory unit of the detection device.

3. The search method according to claim 2, wherein the step of determining at least one localization position of the beacon further comprises initializing the grid in the memory unit so that the center of the grid has fixed reference coordinates defined by an initial position of the detection device determined when starting searching for the beacon.

4. The search method according to claim 2, comprising a step of determining the dimensions of each sub-area according to a memory available in the memory unit of the detection device.

5. The search method according to claim 1, wherein the detection device is moving relative to a terrestrial reference frame and wherein the beacon is fixed relative to the terrestrial reference frame.

6. The search method according to claim 1, wherein the current probability indicator takes account of the determined separation distance between the beacon and the detection device in the form of a distance distribution taking account of a measurement error.

7. The search method according to claim 1, wherein the detection device is provided with a visual interface, the search method comprising a step of displaying on the visual interface in which the sub-areas for which the probability indicator has the highest values are highlighted.

8. The search method according to claim 1, wherein the search space of the beacon is determined from the initial estimate of the separation distance between the detection device and the beacon, and wherein the grid has a dimension larger than at least twice the separation distance initially determined between the detection device and the beacon.

9. The search method according to claim 1, wherein the current geolocation coordinates of the detection device originate from at least one source selected from among: a system for geolocation by one or several satellite, a triangulation based on Wi-Fi access points detected by the detection device, a trilateration based on Wi-Fi access points detected by the detection device, a trilateration based on cellular base stations detected by the detection device, a simultaneous localization and mapping (SLAM) algorithm based on an analysis of a stream of images captured by the detection device, and a unit for integration of axial and angular accelerations measured by a set of accelerometers and gyroscopes.

10. A system for searching for a beacon comprising:
the beacon emitting within a transmission range of the beacon a radio signal comprising identification information of the beacon,
a detection device comprising a geolocation terminal able to determine current geolocation coordinates of the detection device and a radio receiver capable of detecting the radio signal emitted by the beacon, the detection device implementing the search method according to claim 1, the detection device further comprising a memory unit in which are loaded:
a grid which covers a search space of the beacon and which comprises a plurality of sub-areas, each sub-area having relative coordinates calculated with respect to fixed coordinates of a center of the grid, and
probability indicators associated with the sub-areas, so that each sub-area has a probability indicator representative of the probability that the sub-area contains the beacon.

11. The search system according to claim 10, wherein the detection device is configured to measure a separation distance between the detection device and the beacon on the basis of a measurement of a time of propagation of the radio signal between the beacon and the detection device, or a measurement of a quantity representative of the power of the radio signal emitted by the beacon and received by the detection device like an RSSI, or a combination of the measurement of the time of propagation of the radio signal and the quantity representative of the power of the radio signal.

12. The search system according to claim 10, wherein the detection device is moving relative to a terrestrial reference frame and wherein the beacon is fixed relative to the terrestrial reference frame.

13. The search system according to claim 10, further comprising a visual interface in which the sub-areas for which the probability indicator has the highest values are highlighted in the display.

14. The search system according to claim 10, wherein the geolocation terminal of the detection device comprises at least one element selected from among: a system for geolocation by one or several satellite(s), a Wi-Fi or cellular access point detector, an image stream sensor, and an integration unit comprising a set of accelerometers and gyroscopes.

15. The search system according to claim 10, wherein the detection device is included in an aerodyne or a motor vehicle.
